(19) United States
(12) Patent Application Publication
(10) Pub. No.: US 2026/0225016 A1
(43) Pub. Date: Aug. 6, 2026

(54) AIR FILTER MEDIA, RIGID FRAMES, AND AIR FILTERS

(71) Applicant: 3M INNOVATIVE PROPERTIES COMPANY, Saint Paul, MN (US)

(72) Inventors: Michael L. Munson, Maple Grove, MN (US); Mark A. Sanocki, Vadnais Heights, MN (US); Bryan L. Gerhardt, Woodbury, MN (US); judd D. Olson, Deephaven, MN (US); Nicolas W. Tremain, Roseville, MN (US)

(21) Appl. No.: 19/159,941

(22) PCT Filed: Feb. 21, 2024
(86) PCT No.: PCT/IB2024/051677

§ 371 Date: Aug. 26, 2025

Related U.S. Application Data
(60) Provisional application No. 63/452,515, filed on Mar. 16, 2023.

(51) Int. Cl. B01D 46/00; B01D 46/52

(52) U.S. Cl. CPC B01D 46/0005; B01D 46/521; B01D 2265/06

(57) ABSTRACT

Air filter media for air filters; rigid frames for air filters; framed air filters; kits for making framed air filters; and methods for making and using framed air filters. The air filter media may comprise at least one first tether and at least one second tether for securing the air filter media to the rigid frame. The rigid frame may be upstream-open-ended and may comprise at least one tether-securing feature.

### BACKGROUND

Air filters are commonly used in powered air-handling apparatus, e.g. residential and commercial heating and air-conditioning (HVAC) systems, room air purifiers, and so on, in order to remove dust and dirt particles and the like. Conventional air filters have frames that are permanently mounted on the filter media and that dictate that the air filter must exhibit its end-use size when shipped to a retailer, when presented to potential purchasers, and when stored by an end-user. Consequently, these air filters undesirably occupy a relatively large volume of space on transportation vehicles, on retailer shelves, and in end-user's homes.

### SUMMARY

Herein are disclosed air filter media for air filters; rigid frames for air filters; framed air filters; kits for making framed air filters; and methods for making and using framed air filters. In some aspects, the air filter media may comprise at least one first tether and at least one second tether for securing the air filter media to the rigid frame. In some aspects, the rigid frame may be upstream-open-ended and may comprise at least one tether-securing feature. These and other aspects will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a perspective view, generally from an upstream side, of an exemplary framed air filter as disclosed herein.

FIG. 2 is a perspective view of the air filter of FIG. 1, with the air filter media and the rigid frame exploded away from each other.

FIG. 3 is a perspective exploded view, generally from an upstream side, of another exemplary air filter media and rigid frame.

FIG. 4 is a perspective exploded view, generally from an upstream side, of another exemplary air filter media and rigid frame.

FIG. 5 is a perspective exploded view, generally from an upstream side, of another exemplary air filter media and rigid frame.

FIG. 6 is a perspective exploded view, generally from an upstream side, of another exemplary air filter media and rigid frame.

FIG. 7 is a perspective exploded view, generally from an upstream side, of another exemplary air filter media and rigid frame.

Like reference numbers in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “first” and “second” may be used in this disclosure, it should be understood that those terms are used in their relative sense only unless otherwise noted. As used herein as a modifier to a property, attribute or relationship, the term “generally”, unless otherwise specifically defined, means that the property, attribute or relationship would be readily recognizable by a person of ordinary skill but without requiring absolute precision or a perfect match (e.g., within +/−20% for quantifiable properties). The term “substantially” means to a high degree of approximation (e.g., within +/−10% for quantifiable properties) but again without requiring absolute precision or a perfect match. The term “configured to” and like terms is at least as restrictive as the term “adapted to”, and requires actual design intention to perform the specified function rather than mere capability of performing such a function.

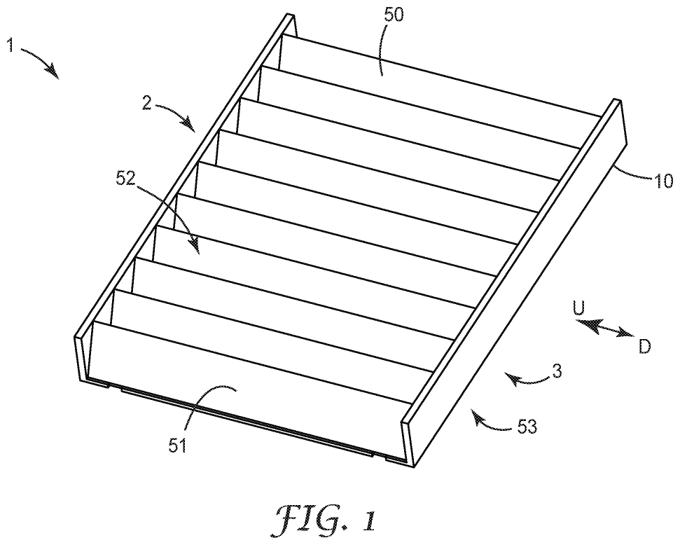

The term “upstream” is used to denote a side of a framed air filter upon which, with the framed air filter installed in a powered air-handling apparatus, moving air will impinge on the framed air filter to be filtered thereby. The term “downstream” is used to denote the side of such an air filter from which filtered air will exit. FIG. 1 is marked with an upstream-downstream axis with “U” and “D” directions indicated to aid in recognition of upstream and downstream sides of the air filters and components thereof. Terms such as “outer”, “outward”, “outwardmost”, “outwardly”, and the like, refer to directions generally away from the geometric center of the framed air filter (and generally perpendicular to the upstream-downstream axis of the framed air filter). Terms such as “inner”, “inward”, “inwardmost”, “inwardly”, and the like, refer to directions generally toward the geometric center.

### DETAILED DESCRIPTION

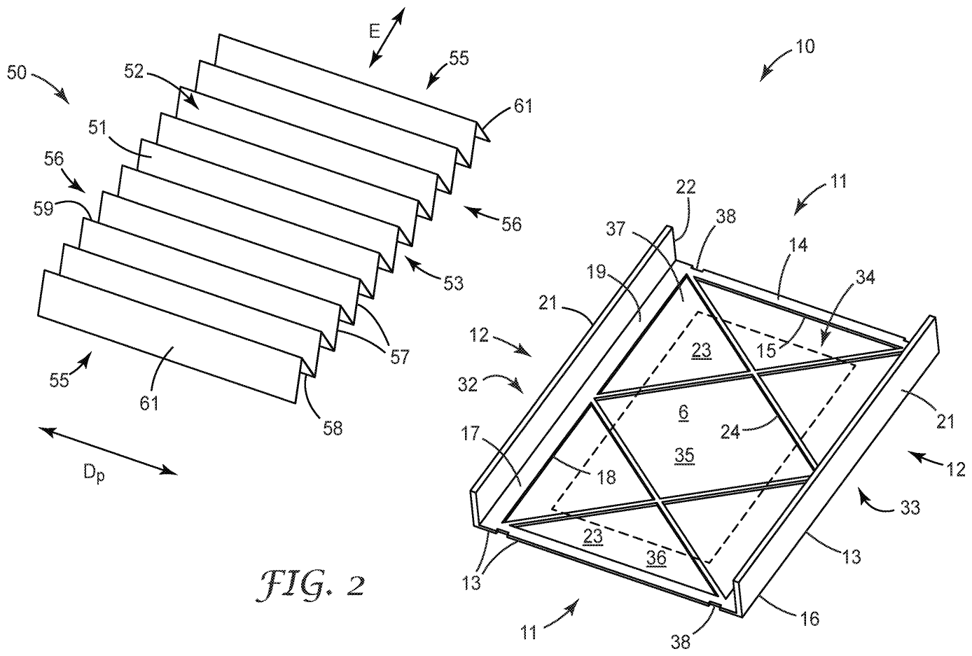

Shown in FIG. 1 in perspective view generally from the upstream side, and presented in a similar orientation in exploded view in FIG. 2, is an exemplary framed air filter 1 as disclosed herein. Framed air filter 1 comprises an upstream side 2 and a downstream side 3 as defined and described above. Framed air filter 1 comprises pleated air filter media 51 (often, in the form of a “pleatpack” 50 as described later herein) and rigid frame 10 that defines a space 6 into which pleatpack 50 can be received to form air filter 1. Pleatpack 50, rigid frame 10, and a framed air filter 1 formed therefrom, will all be at least generally rectangular in shape (which specifically includes square shapes) when viewed along the upstream-downstream axis of the framed air filter.

Disclosed herein are rigid frames 10 that are configured to receive an air filter media to form a framed air filter. Exemplary rigid frame 10 as depicted in FIGS. 1 and 2 comprises an upstream-downstream axis (that coincides with that of the framed air filter formed therefrom) and an upstream side 32 and a downstream side 33, and comprises first and second opposing ends 11 and first and second opposing sides 12 as evident in FIG. 2. Frame 10 comprises a downstream base 13 that is generally planar so as to exhibit a major plane that is oriented at least generally perpendicular to the upstream-downstream axis of the frame. Downstream base 13 comprises first and second opposing elongate side-members 16 that are connected to each other by first and second opposing elongate end-members 14 respectively located at the first and second opposing ends 11 of the frame. Side-members 16 and end-members 14 are all integral with each other and are arranged so that downstream base 13 exhibits a rectangular, picture-frame shape (thus in many embodiments, members 16 and 14 are all coplanar with each other). Inward edges 18 of side-members 16, and inward edges 15 of end-members 14, collectively define an air-transmissive window 23. In some embodiments, side-members 16 may each include an inwardmost portion 17 (indicated in FIG. 2) that serves as a downstream support flange for corrugated edge sections of a pleated filter media as described in detail later herein. In many such embodiments, portion 17 may be an integral portion of side-member 16 and may be at least substantially coplanar with the other portions of side-member 16. (Here and elsewhere, by integral is meant that two items are made of the exact same material, formed at the same time in the same operation, as distinguished from items that are made separately and then attached to each other.) Rigid frame 10 further comprises first and second opposing, parallel, elongate sidewalls 21 that are located on first and second opposing sides 12 of frame 10 and that respectively integrally extend from the first and second opposing elongate side-members 16 of downstream base 13 in a generally upstream direction. In the exemplary embodiment depicted in FIGS. 1 and 2, sidewalls 21 define a space 6 into which an air filter media is received; in other embodiments discussed later herein, endwalls may be present which further define this space.

Rigid frame 10 further comprises at least one downstream support member 24 that is integral and coplanar with downstream base 13 and that integrally extends from one elongate side-member 16 to the other, opposing elongate side-member 16 and/or to at least one of the first and second opposing elongate end-members 14. In many embodiments, multiple downstream support members 24 may be present e.g. in the form of a lattice as visible in exemplary embodiment in FIG. 2. Whatever the specific arrangement, the downstream support member(s) 24 will be configured so that window 23 is amply air-transmissive.

### Upstream-Open-Ended Frames

Whatever the specific arrangement, in at least some embodiments at least one such downstream support member 24 will cross a core area 35 of air-transmissive window 23. By a core area is meant an area that (when viewed along the upstream-downstream axis of the framed air filter) is centered on the geometric center of window 23, that occupies 50% of the total nominal area of window 23, and that has the same shape and aspect ratio as window 23. (Exemplary core area 35 is indicated by the dotted-line rectangle in FIG. 2.) In many embodiments air-transmissive window 23 will be at least generally rectangular; in such a case core area 35 will similarly be an at least generally rectangular shape that is symmetrically centered on the geometric center of window 23. By a nominal area of window 23 is meant an area collectively defined by the inward edges 18 of side-members 16 and the inward edges 15 of end-members 14, disregarding the area occupied by the support member(s). The remainder of window 23 that is not included in core area 35, will be termed a peripheral area 36 as denoted in FIG. 2.

In at least some embodiments, rigid frame 10 is upstream-open-ended. By this is meant that any component of frame 10 that is located upstream from downstream base 13, does not extend over, or cross into or over, core area 35, so that frame 10 will thus exhibit an open upstream face 34. This requirement will be evaluated while viewing frame 10 along the upstream-downstream axis, from the upstream side; any component of frame 10 that overlies any portion of core area 35 when viewed from such an orientation, will be deemed to extend into or over core area 35.

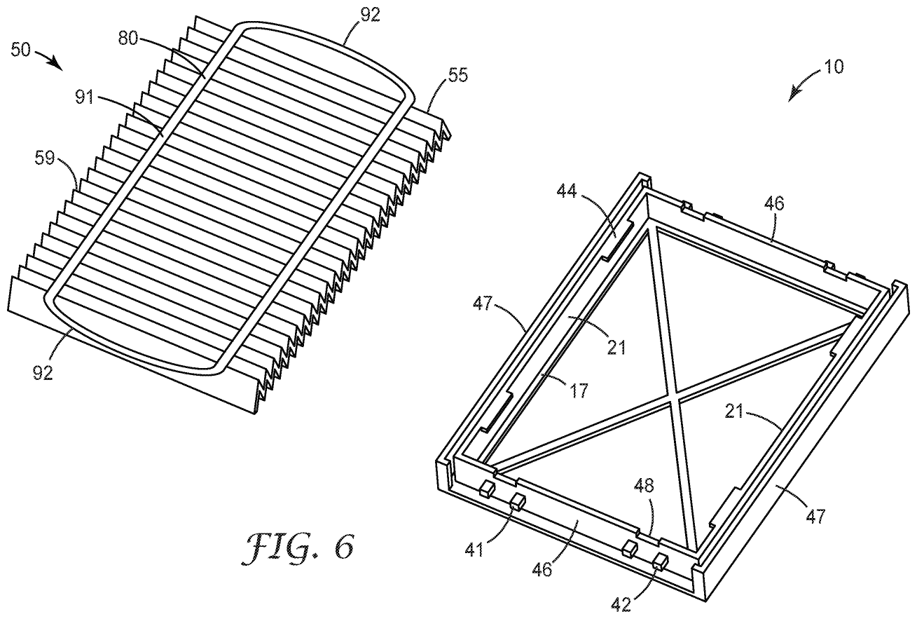

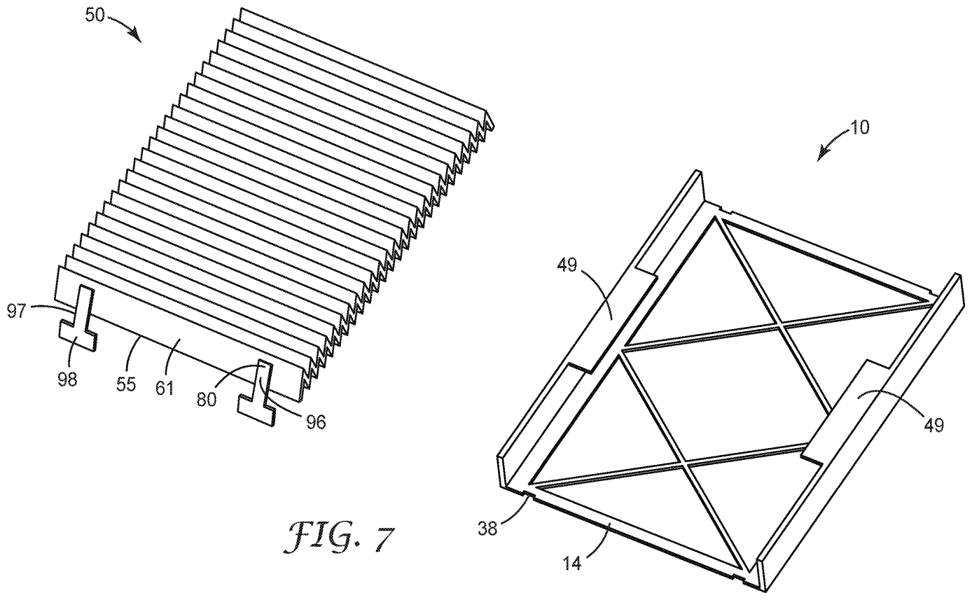

In some embodiments, the above requirement that frame 10 must be upstream-open-ended may be achieved by providing that the only components of frame 10 that are located upstream of downstream base 13, are the above-described sidewalls 21. In other embodiments, one or more upstream components may be present and may even extend partially into (that is, may overlie) portions of window 23 (i.e., they may overlie some portion of the above-described peripheral area 36 of window 23); however, they will not extend so far inward as to overlie core area 35. In some embodiments, such components may take the form of upstream side-tabs of the general type visible as upstream side-tabs 44 of FIG. 6 or upstream side-tabs 49 of FIG. 7. However, in some embodiments at least 60, 70, 80, 90, 95, or even 100 % of the nominal area of air-transmissive window 23 will not be overlain by any upstream component of rigid frame 10. (In this context, any entity that is component of, or is associated with, an air filter media that is installed into frame 10, will not be considered to be a component of frame 10.) If present, one or more upstream side-tabs (e.g. of the general type depicted as tabs 44 in FIG. 6 or tabs 49 of FIG. 7) may enhance the stability with which a pleatpack 50 of pleated filter media 51 is retained by the rigid frame 10, without significantly detracting from the upstream-open-ended nature of the rigid frame and the framed air filter.

In many embodiments, frame 10 may be a single-piece, integral item in which all components of the frame (e.g. a downstream base and side-members and end-members thereof; sidewalls (and endwalls if present); downstream support members; and so on) are integral with each other. By rigid is meant that frame 10 is not foldable. Frame 10 will likely be made of a common injection-moldable thermoplastic material (e.g. nylon, polypropylene, ABS, etc.) or of cardboard, chipboard or the like, and thus will likely be somewhat flexible when subjected to torsion. Thus, the term “rigid” does not mean that frame 10 must be absolutely resistant to any slight flexing when subjected to torsion as a whole; rather, this simply means that frame 10 is configured so that it is not foldable into a smaller shape or volume e.g. for storage.

It will be appreciated that an upstream-open-ended frame 10 as described above may possess various advantages, e.g. the frame is simple and economical to manufacture, and allows a filter media to be easily installed into the frame. (For example, the installation does not require a two-piece frame to be separated into component pieces, nor does it require the cover of a “clamshell” style frame to be opened). In some embodiments a rigid frame 10 may comprise one or more tether-securing features as discussed in detail later herein.

Disclosed herein are pleated air filter media 51 configured to be installed into a rigid frame to form a framed air filter. By “pleated” is meant an air-filter media (e.g. a fibrous web) that has been folded into rows of generally parallel, oppositely oriented folds that provide alternating peaks and valleys on both sides of the media. For example, and as shown in FIG. 2, the pleated filter media 51 includes a plurality of pleats 57 and comprises elongate upstream pleat tips 59 and elongate downstream pleat tips 58. Such pleated media will comprise an upstream face 52 and a downstream face 53 and will exhibit a pleat direction (Dₚ) that is parallel to the long axes of the elongate pleat tips. Various parameters of the pleated media (e.g. pleat spacing, pleat height, and so on) can be chosen as desired; typically such parameters will be chosen for the pleated filter media in its expanded, end-use configuration as discussed below. The pleated structure allows the filter media to be “accordionized” into a collapsed configuration in which the pleat tips (and pleat panels) are crowded quite close together or even in contact with each other, and then expanded into the end-use configuration at the desired time.

A pleated filter media 51 may often be provided to an end-user in the form of a pleatpack, which, in the simplest incarnation, may be a pleated filter media that has been cut to a particular configuration (e.g., length and width) in view of the desired dimensions of the filter media in its end-use condition. In some embodiments, one or more other items (e.g. one or more tethers, and/or one or more expansion-limiting and/or pleat-spacing-defining members, all as discussed later herein) may be added to the pleated filter media to form the pleatpack. As noted, in some embodiments a filter media (e.g., pleatpack) may be provided in a collapsed configuration, and expanded into the end-use configuration by an end-user. However this does not have to be strictly the case. That is, in some embodiments, a pleated filter media 51 as provided to an end user may be in expanded, end-use condition. However, in some embodiments, since the media is unframed, an expanded media (e.g. in the form of multiple pleatpacks) may be e.g. stacked in a nested manner for space savings.

Thus in at least some embodiments, a pleated filter media 51 can be expanded at least once from a collapsed condition to an expanded, end-use condition. The expansion can be performed along an expansion direction E as indicated in FIG. 2; in many embodiments, the pleated media can only expand along this single direction. In some embodiments, the pleated media can be repeatedly transitioned back and forth between an expanded, end-use condition and a collapsed condition. However, in some embodiments the pleated filter media may only need to be expandable from a collapsed condition to an expanded, end-use condition (e.g., a condition in which the pleated filter media has a span that matches the dimension of a filter receptacle of a powered air-handling apparatus) a single time. That is, in some such embodiments, the pleated filter media may not need to be collapsible back to the original collapsed condition.

The pleated filter media 51 may be configured to quickly and easily transition from a collapsed configuration to an expanded, end-use configuration. In some embodiments, a removable wrapper or other packaging can be provided to initially retain the air filter media in the collapsed state, and can be removed to allow expansion. The air filter media does not require a conventional, factory-installed rigid frame permanently surrounding the pleated filter media, and can advantageously be shipped, inventoried, displayed, and so on, in the collapsed state if desired.

At least when expanded into an expanded configuration, a pleated filter media 51 can have a rectangular shape with a rectangular perimeter. The pleated filter media 51 will have an upstream face 52 and a downstream face 53, although in some embodiments these may be interchangeable. The pleated filter media will comprise first and second opposing edges 55 which will be termed “primary” opposing edges. Each primary edge will comprise an end pleat-panel 61.

The pleated filter media 51 will further comprise first and second opposing edges 56, which will be termed “secondary” opposing edges. By definition, these secondary edges 56 are “corrugated edges” (that exhibit a zig-zag shape when viewed along the pleat direction Dₚ, as is evident from FIG. 2); also by definition, the above-described primary opposing edges 55 are non-corrugated edges. In a framed air filter 1, the primary edges 55 of the pleated media will be located at the “ends” 11 of the frame (in many cases, primary edges 55 will reside at or on the above-described end-members 14). In a framed air filter 1, the secondary/corrugated edges 56 of the pleated media will be located at the “sides” 12 of the frame. (In other words, the portions of the frame at which the corrugated edges of the pleated media are located will be termed the “sides” of the frame; the frame portions at which the primary edges of the pleated media are located will be termed the “ends” of the frame.) Often, these secondary, corrugated opposing edges 56 will be closely abutted against (e.g. in contact with) an inward surface 22 of a frame sidewall 21. Also, downstream pleat tips 58 of secondary/corrugated edge sections of the pleated filter media 51 may be closely abutted against (e.g. in contact with) an upstream surface 19 of a downstream support flange 17 of a side-member 16 of rigid frame 10.

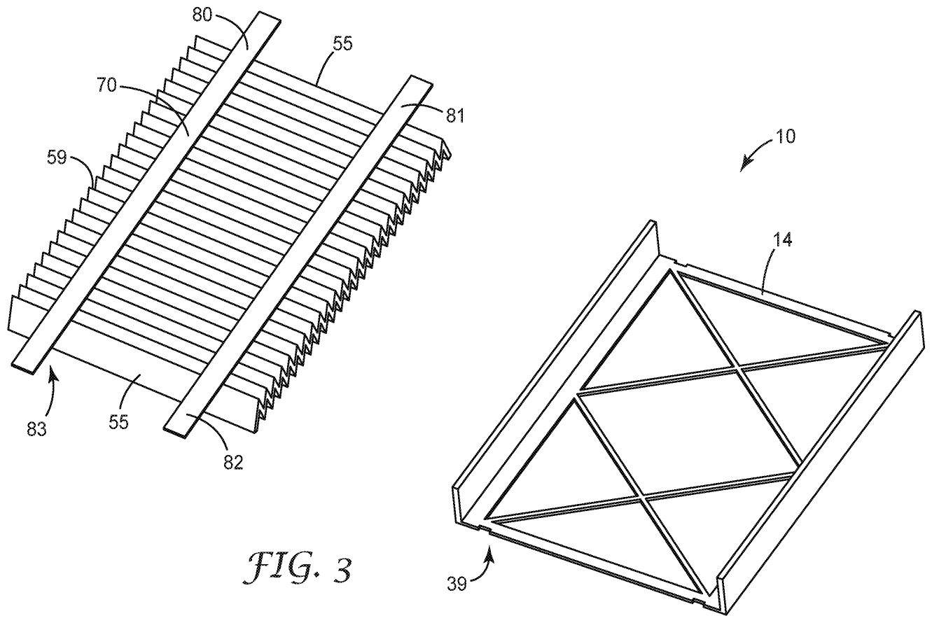

In some embodiments, a pleatpack 50 may include other components in addition to the pleated filter media 51 (and tethers as discussed later herein). Thus in some embodiments, a pleatpack 50 may include one or more entities 70 that are configured e.g. to limit the expansion of the pleated media to a desired overall length for a particular end-use, and/or to establish, limit, and/or stabilize the pleat spacing of the pleated media. In the exemplary illustrations of FIG. 3, such entities 70 are in the form of elongate ribbons that are bonded to pleat tips of the pleated media. However, in various embodiments, any such entity or entities may take the form of a nonwoven scrim, a netting, a wire mesh, a set of filaments, and so on. In some embodiments any such entity may be bonded only to the pleat tips of the pleated media. In some embodiments, such entities may take the form of a set of extruded filaments of the general type described in U.S. Patent Application Publications 2021/0229022 and 2021/0229023, both of which are incorporated by reference in their entirety herein. In some embodiments, any such entities will be flexible (e.g. so that the entities can fold or gather to accommodate their excess length when the pleated media is collapsed); however, in some such embodiments, any such entities will be inelastic so as to limit the expansion to a desired amount that establishes a desired end-use pleat spacing. For example, such an entity could be in the form of one or more ribbons, strips, filaments, etc. that is attached to the pleat tips and that, when extended to its maximal length, provides a “dead-stop” at a desired span. Thus in some embodiments such an entity may be non-elastic, meaning that it exhibits an elongation at break of less than 5%. In some embodiments such an entity may be at least somewhat elastic (with an elongation at break of over 5%) or highly elastic (with an elongation at break of over 100%). In various embodiments, any such entities 70 may be present on the upstream face 52 of the pleated air filter media 51 (as in the exemplary illustration of FIG. 3), on the downstream face 53 of the media or on both. In some embodiments, it may be convenient that any such entities 70 are on the upstream side of the filter media; thus in some particular embodiments, such entities 70 may be present on the upstream side of the filter media but not on the downstream side of the filter media.

The pleated air filter media 51 may be of any suitable type and composition. The air filter media is typically sheet-like, with (with the media in an expanded condition) a “length” along the expansion direction E, and a width along the pleat direction Dₚ, that are considerably greater than the thickness of the air filter media. In the exemplary illustration of e.g. FIG. 2, the “length” of the pleatpack along the expansion direction is greater than the “width” along the pleat direction. However, this does not necessarily have to be the case; a pleatpack may be “wider” than it is “long”.

In some embodiments, the filter media may be, or include, a nonwoven material. In some embodiments, the filter media may comprise fiberglass fibers. Nonwoven webs which may be used as, or as a layer, of, the filter media can be a high loft spunbond web, such as described, for example, in U.S. Pat. No. 8,162,153. In some embodiments, the filter media can be, or include, a low loft spunbond web, such as those described in U.S. Pat. No. 7,947,142. In some embodiments, an electrostatic charge is optionally imparted into or on to material(s) of the filter media. Thus, the filter media can be an electret nonwoven web. Electric charge can be imparted to the filter media in a variety of ways as is well known in the art, for example by hydrocharging, corona charging, etc. (e.g. as described in U.S. Pat. No. 7,947,142). In other embodiments, the filter media is not electrostatically charged. Pleats can be formed in the filter media using various methods and components as are well known in the art, for example those described in U.S. Pat. Nos. 6,740,137 and 7,622,063.

In some embodiments, a pleated air filter media may comprise one or more removal tabs (not shown in any Figure) e.g. at or near the first and second primary edges of the pleated air filter media. Such removal tabs may be configured to be grasped by an end-user and pulled e.g. in a generally upstream manner to initiate and/or assist the removing of the pleated media from the frame. Accordingly, in some embodiments any such removal tab(s) may be on the upstream side of the filter media. Such a removal tab may be e.g. attached (via any suitable arrangement) e.g. to an end pleat panel 61 of the pleated media, to one or more pleat panels that are close to the primary edge of the filter media, or at any suitable location, as desired. Typically, any such removal tab may not need to extend along the entire width of the filter media in the pleat direction; all that is needed is that one or more removal tabs be provided that are of sufficient size to be easily grasped. In some embodiments, no removal tab(s) will be present.

In some embodiments, a rigid frame 10 as disclosed herein may be provided to an end user in the form of a kit that also includes one or more pleatpacks 50 of filter media 51. In some embodiments, such a kit may include a single rigid frame (that can be reused with successive pleatpacks) and a large number (e.g. three, five, ten, twenty, or more) of pleatpacks. As noted, in some cases the individual pleatpacks may be provided in the kit in a collapsed condition to be expanded to an end-use configuration by the end user. In some such cases, such a kit may have a “starter” pleatpack that is factory-installed (e.g. in the end-use configuration) in the rigid frame, along with multiple replacement pleatpacks (that are e.g. in a collapsed condition). In view of the likely mode of use (multiple pleatpacks being successively used in a single, reusable rigid frame), replacement pleatpacks may be available in the form of replacement filter packs that include one, or multiple, collapsed pleatpacks and that do not include a rigid frame.

A pleatpack 50 may be installed in a rigid frame 10 in a simple and straightforward manner by inserting the pleatpack into the above-described receiving space 6 defined by the frame. In some embodiments (particularly if no upstream side-tabs of the general type depicted as tabs 44 in FIG. 6 or tabs 49 in FIG. 7 are present, or if any such upstream side-tabs are sufficiently small in size) the pleatpack can be inserted into receiving space 6 by moving the pleatpack in a downstream direction into space 6. In other embodiments (e.g. if upstream side-tabs are present), the pleatpack may be slidably moved e.g. in a direction along the expansion direction of the pleatpack. For example, the pleatpack may be slidably inserted through an open end 11 of the rigid frame e.g. if there are no endwalls at ends 11 of the frame.

The pleatpack may be expanded generally or substantially to its expanded, end-use state before being installed in the rigid frame; or, the pleatpack may be at least partially installed while still in a collapsed condition and can then be expanded during the installation. The latter procedure may be convenient e.g. in cases in which the rigid frame has both endwalls 46 and upstream side-tabs (as in the exemplary arrangement shown in FIG. 6). In such a case, the pleatpack may be retained at least generally in its collapsed form so that it can be inserted in a downstream direction into receiving space 6 (passing between the pairs of upstream side-tabs 44 in the process) after which the pleatpack may be expanded to its end-use configuration.

### Tethers

In at least some embodiments, a pleatpack 50 may comprise one or more tethers 80 (in the Figures, reference number 80 indicates tethers in general; numbers 81, 84, 86, 91, and 96 indicate specific types of tethers). As indicated in generic representation in FIG. 3, in some embodiments one or more first tethers 81 may be provided that are configured to extend outward beyond a first primary edge 55 of the pleatpack, and one or more second tethers 81 may be provided that are configured to extend outward beyond a second, opposing primary edge 55 of the pleatpack. The terminology of first and second tethers are with reference to the first tether(s) extending from the first primary edge of the pleatpack and the second tether(s) extending from the second, opposing primary edge of the pleatpack. This nomenclature is used for ease of description and is non-limiting. As apparent from FIG. 3, in some embodiments a “first” tether and a “second” tether may be provided by opposite ends of a single entity. The terminology of first and second tethers will be maintained to emphasize the opposed locations and orientations of the respective first and second tethers, regardless of whether or not they are e.g. discrete entities or are opposing portions of a single entity.

In many embodiments, the at least one first tether and the at least one second tether may be similar or identical (as in the exemplary illustration of FIG. 3) excepting their location and orientation. In the illustrated embodiment of FIG. 3, there are a pair of first tethers at a first primary edge of the pleatpack, and a pair of second tethers at a second primary edge of the pleatpack. Each tether is provided by an elongate member with the tethers of each pair being spaced apart from each other along the pleat direction of the pleatpack.

Each such tether includes a portion 82 that extends beyond the primary edge 55 of the pleatpack and that is configured to interact with a rigid frame 10 in a manner that enhances the security of the pleatpack in its installed condition on the frame. In one simple embodiment, an extending portion 82 of a tether 81 may be wrapped in an upstream direction so that it contacts an end-member 14 of a rigid frame, and may be attached, bonded, etc., to the end-member. For example, an extending portion 82 might have a patch 83 of pressure-sensitive adhesive e.g. on its downstream surface; the portion 82 may be wrapped around a segment of the end-member 14 and so that the patch of adhesive contacts, and adhesively bonds to, a downstream surface of end-member 14. If desired a landing zone 39 may be provided on a designated area of the surface of end-member 14; such a zone may be e.g. treated to render it particularly adhesive-receptive. Other possibilities include providing hook and loop fasteners on portion 82 of tether 81 and on a complementary landing zone of end-member 14 (the hook portion and loop portion may be on either item, as desired).

In the exemplary arrangement of FIG. 3, a tether 80 may also serve as a previously-described expansion-limiting and/or pleat-stabilizing entity 70. In such embodiments, the tether(80)/stabilizer(70) may be bonded to some or all of the upstream pleat tips 59. In some such embodiments, a tether 80 may thus be an extension, e.g. an integral extension, of an entity 70. However, even if a tether is not an integral extension of an entity 70, any such entity 70, if present, may provide a convenient item to which a tether may be attached (so that, for example, the tether need not necessarily be attached directly to the pleated media itself, although it can be if desired). Thus in some embodiments, a tether 80 (of any type and design) may be attached (in any desired manner) to a stabilizing entity 70, with the attachment being performed either before or after the entity is attached to the pleated media.

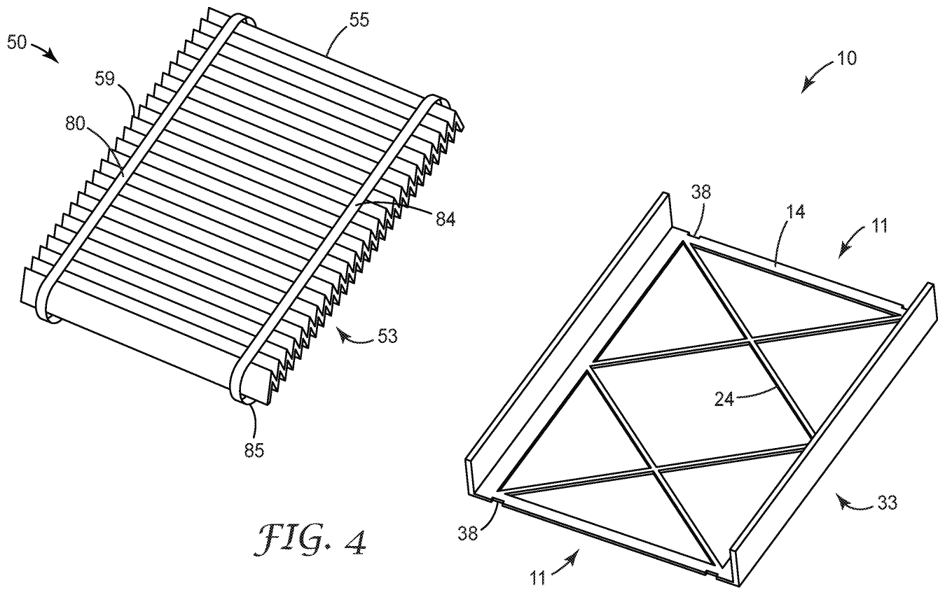

Another exemplary arrangement is depicted in FIG. 4. In this arrangement, each tether 80 is provided by an elongate member 84 that includes a segment that is attached to multiple upstream pleat tips 59 of the rectangular pleated air filter media. In the depicted arrangement, each elongate member 84 is in the form of a continuous loop that extends around the first and second primary edges 55 of the pleatpack and that includes a segment 85 that extends along a downstream face 53 of the pleatpack. Each such elongate member is configured so that, with the pleatpack placed in a rigid frame 10, each elongate 84 member can extend around first and second ends 11 of the rigid frame and pass along a downstream side 33 of the frame to secure the rectangular pleated air filter media to the frame.

In the exemplary arrangement of FIG. 4, the first and second end-members 14 of the downstream base 13 of frame 10, each comprise outward-facing notches 38 that are provided in the outward edges of the end-members 14. Each such notch can allow a segment of elongate member 84 to be seated in the notch so that each continuous loop is more securely held in a designation location and orientation. As such, each such notch may be considered to be a tether-securing feature of frame 10.

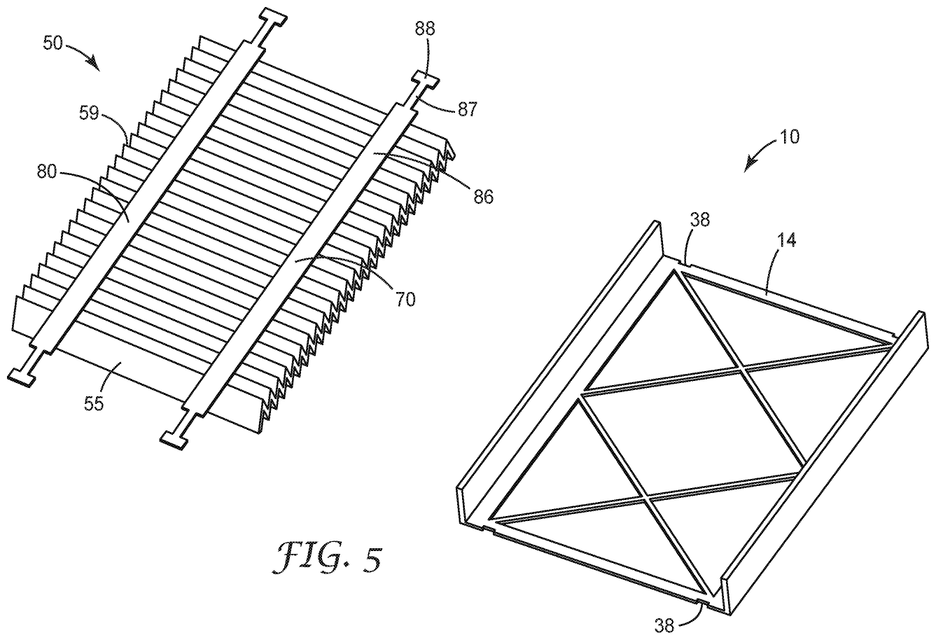

Another exemplary arrangement is depicted in FIG. 5. In the illustrated embodiment, each tether 80 is provided by an elongate member 86; each such tether includes a portion that extends beyond the primary edge 55 of the pleatpack and that is configured to interact with a rigid frame 10 in a manner that enhances the security of the pleatpack in its installed condition on the frame. In the depicted embodiment, each extending portion of the tether comprises a narrow neck portion 87 and an enlarged head portion 88. The extending portion may be e.g. wrapped in an upstream direction to contact an end-member 14 of the rigid frame, with the narrow neck portion 87 of the tether being seated in a tether-seating notch 38 of the end-member 14, so that the enlarged head portion 88 tends to keep the tether seated in notch 38. It will be appreciated that FIG. 5 is an exemplary, representative depiction in order to depict the general premise of a tether that relies on an enlarged head portion and a narrowed neck portion; in actuality, such portions may be configured in any of a variety of ways e.g. to enhance the ability of the tether to remain secured to the frame. Similarly, a tether-securing feature of the frame may be something other than a simple outward-facing notch 38.

In other aspects the exemplary tethers 86 of FIG. 5 are similar to those of e.g. FIG. 3. The tethers comprise elongate members in the form of ribbons that are bonded to upstream pleat tips 59 of the pleated filter media, two such elongate members being provided in spaced-apart configuration, with each elongate member comprising a first tether at a first primary edge of the pleatpack and a second tether at a second primary edge of the pleatpack.

Another exemplary arrangement is depicted in FIG. 6. In the depicted embodiment, all tethers 80 (e.g. a first tether at a first primary edge of the pleatpack, and a second tether at a second, opposing primary edge of the pleatpack) are provided by a single elongate member 91 in the form of a continuous loop that comprises first and second parallel, spaced-apart segments that are each attached to multiple upstream pleat tips 59 of the rectangular pleated air filter media. The continuous loop 91 further comprises a first section 92 that extends outward beyond a first primary edge 55 of the rectangular pleated air filter media and a second, opposite section 92 that extends outward beyond the second, opposite primary edge of the rectangular pleated air filter media. The first section 92 of the continuous loop can be secured to at least one first tether-securing feature at the first end of a rigid frame and the second section 92 of the continuous loop (which may be identical to the first section except for its location and orientation, as evident in FIG. 6) can be secured to at least one second tether-securing feature at the second end of the rigid frame.

The exemplary rigid frame 10 depicted in FIG. 6 comprises first and second opposing, parallel, elongate endwalls 46 that respectively integrally extend from the first and second opposing elongate end-members 14 of the downstream base 13 (not specifically indicated in FIG. 6, but identified e.g. in FIG. 2) of frame 10 in a generally upstream direction. In the depicted embodiment, the tether-securing features of each endwall comprise at least one first post that protrudes outward from an outward face of the first elongate endwall 46 and at least one second post that protrudes outward from an outward face of the second, opposing, parallel, elongate endwall 46, the at least one second post protruding outward in an opposite direction from the at least one first post. In the particular embodiment shown in FIG. 6, there are a pair 41/42 of first posts that are on the first endwall 46 and that are spaced apart from each other at least generally along a long axis of the first elongate endwall, and a similar pair 41/42 of second posts that are on the second, opposing endwall 46 and that are spaced apart from each other at least generally along a long axis of the second, opposing, elongate endwall. In the particular embodiment of FIG. 6, two such pairs are located on each endwall.

As evident from FIG. 6, the extending portion 92 of continuous loop tether 91 can be positioned so that it passes around at least one post of each of the two pairs of posts on each endwall, in order to secure the pleatpack to the frame. In some embodiments, the extending portion 92 of the tether may be passed around the inward posts 41 of each pair; or (e.g. to provide a tighter hold), the extending portion 92 may be passed around the outward posts 42 of each pair. It will be appreciated that many variations on such arrangements are possible. For example, notches 48 may be provided that are at the upstream edge of endwall 46 and that may further assist in keeping the continuous loop 91 seated in the desired location and arrangement. It will also be appreciated that a pair of posts 41/42 may provide a securing feature for a narrow-neck/enlarged-head tether of the general type depicted in FIG. 5. That is, rather than such a tether being secured onto a notch 38 as in FIG. 5, the enlarged head of such a tether may be secured downstream of two such posts (with the narrow neck passing upstream between the posts), in order to secure the tether to the frame.

As noted above, the rigid frame 10 as depicted in FIG. 6 differs somewhat from the frames presented earlier herein, e.g. by way of comprising endwalls 46 in addition to sidewalls 21 (so that the filter-receiving space 6 is in the form of a true “box” that bounds the pleatpack on all four sides/ends). Frame 10 as depicted in FIG. 6 also differs by way of comprising upstream side-tabs 44 as discussed earlier herein. Frame 10 as depicted in FIG. 6 also differs in having double-walled sides by virtue of “extra” outwardmost sidewalls 47 in addition to the previously-described sidewalls 21. This was done for prototyping in view of other aspects which are not particularly relevant to the present disclosures; thus, the “extra” sidewalls 47 as depicted in FIG. 6 may be omitted so that the resulting frame more closely resembles the other frames described herein. Finally, frame 10 as depicted in FIG. 6 differs in having downstream support flanges 17 that are rather narrow; in actuality, the width of any such support flange may be chosen in view of the specific arrangement.

Another exemplary arrangement is depicted in FIG. 7. In the depicted embodiment, all tethers 80 are in the form of discrete entities 96 that are attached to an end pleat-panel 61. In the depicted embodiment, the tethers 96 are in the form of narrow neck (97)/enlarged head (98) entities that can be secured e.g. to a notch 38 or to a pair of posts in the manner described above. However, this is merely illustrative; the larger purpose of FIG. 7 is to emphasize that any tether, or any type of tether, may be a discrete entity that is attached to an end pleat-panel 61 rather than e.g. being an extension of an elongate member that is attached to multiple upstream pleat tips of the pleated media. Again, many variations are possible. For example, in some embodiments two, three or more pleat-panels at the end of the pleatpack may be gathered together and e.g. bonded or otherwise attached to each other, with a tether then being attached to the resulting multilayer end pleat-“panel”. It is also possible to provide one or more apertures in an end pleat-panel (or in a gathered stack of end pleat-panels) to facilitate the attaching of a tether to the pleat-panel or panels.

The rigid frame of FIG. 7 differs slightly from some others disclosed herein in depicting upstream side-tabs 49. In a slight variation from tabs 44 as presented in FIG. 6, tabs 49 of FIG. 7 are present as a single tab along each sidewall, located at the midpoint of the sidewall. (Still other arrangements are possible; e.g. a frame may comprise an upstream strut that crosses a corner 37 of peripheral area 36 of window 23.) While the exemplary frame of FIG. 7 provides tether-seating features in the form of notches 38, it is also possible to use posts (or, in general, any mechanical structure that provides a suitable seating capability) in the general manner shown in FIG. 6.

It will again be appreciated that many variations are possible within the above-provided general concepts. For example, a tether may comprise any suitable connector, e.g. in the form of a snap, clasp, clip, buckle (e.g. a side-release buckle often referred to as a YKK-style buckle), or the like, and may be configured to connect to a complementary connector of the rigid frame. In general, a tether may include, or be derived from, e.g. a relatively wide or narrow elongate ribbon (e.g. that is rather flat in cross-sectional shape) or from a cord or leash that exhibits a relatively circular or rounded cross-sectional shape. A tether may be inelastic (e.g. with an elongation at break of less than 5%), or it may be at least somewhat elastic (with an elongation at break of over 5%) or highly elastic (with an elongation at break of over 100%).

As noted earlier, when a pleatpack 50 is installed into rigid frame 10, downstream support flanges 17 of side-members 16 will underlie (in a downstream direction) the secondary/corrugated edges 56 of the pleated filter media 51. In some such embodiments at least some portions of the outward, corrugated (secondary) edges 56 of pleated filter media 51 may closely abut (e.g. within 1.0, 0.5, or 0.2 mm) the inward surface 22 of frame sidewall 21. In some embodiments, at least some portions of these corrugated edges 56 may be in contact with some portions of inward surface 22. In some embodiments frame 10 may comprise resilient gasketing material (e.g. strips of resilient foam or fibrous material, e.g. with an adhesive backing) that is attached to inward surfaces 22 of sidewalls 21 to minimize any airflow around the corrugated edges of the air filter media. However, in most instances this has not been found to be necessary; thus, in some embodiments, no such gasketing or space-filling material (whether as an adhesive-backed strip or of any other construction) will be present on surface 22.

As noted earlier, in some embodiments a pleated filter media 51 may be provided to an end user in expanded, end-use condition (rather than in a collapsed condition). In further variations, a filter media may make use of the arrangements disclosed herein (e.g., it may be installed into an upstream-open-ended frame and/or may be secured to a frame with tethers) without necessarily being pleated. Thus in various embodiments, a filter media may be e.g. a generally flat media, or may exhibit permanent ridges, waves, or undulations, rather than foldable pleats. Any such filter media will of course be provided in an unframed condition for insertion into a rigid frame in the general manner discussed herein.

As discussed in detail earlier herein, in some embodiments one or more tethers may be used to enhance the security with which a pleatpack is retained in place on a rigid frame. In at least some embodiments, this can be achieved without having to use any further attachment methods such as e.g. adhesively bonding any portion of the pleated media to the frame. In particular, in some embodiments the pleated filtration media may be held in place without having to pinch any portion of the pleated filtration media between portions of the frame e.g. in a “clamshell” fashion. In some embodiments, a filter media may comprise one or more tethers that are configured to (when the filter media is installed in a rigid frame) secure to, wrap around, etc., the sides of the rigid frame rather than the ends of the rigid frame. Any such tether(s) may be present instead of, or in addition to, any tethers (e.g. of the type already described herein) that are associated with the ends of the rigid frame. In such embodiments, a sidewall and/or side-member of the rigid frame may comprise one or more tether-securing features, e.g. of the general type described earlier herein.

A framed air filter 1, made by assembling a pleatpack into a rigid frame in the general manner described herein, can be inserted into a suitable receptable of a powered air-handling apparatus. The term powered air-handling apparatus encompasses, among others, room air purifiers and forced-air heating-ventilating-air-conditioning (HVAC) systems. In this context, the term HVAC broadly encompasses systems that perform only heating, systems that perform only cooling, and systems that perform both (of course, such systems can also be operated to recirculate and filter air, even if the system is neither heating or cooling at the time). At a desired time (e.g. if it is considered that the pleated filter media is approaching the end of its useful life) the framed air filter can be removed from the receptable of the powered air-handling apparatus. The pleatpack can then be removed from the rigid frame and a fresh pleatpack inserted, after which the framed air filter can be inserted into the powered air-handling apparatus.

It will be apparent to those skilled in the art that the specific exemplary embodiments, elements, structures, features, details, arrangements, configurations, etc., that are disclosed herein can be modified and/or combined in numerous ways. In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A rigid frame configured to receive and accept a rectangular pleated air filter media, the frame having an upstream-downstream axis and first and second opposing sides and first and second opposing ends, and the frame comprising:
a downstream base that is generally planar with a major plane that is oriented perpendicular to the upstream-downstream axis of the frame, the downstream base comprising first and second opposing elongate side-members connected by first and second opposing elongate end-members respectively located at the first and second opposing ends of the frame, the side-members and end-members all being integral with each other and being arranged so that the downstream base exhibits a rectangular, picture-frame shape, with inward edges of the side-members and inward edges of the end-members collectively defining an air-transmissive window,
at least one downstream support member that is integral and coplanar with the downstream base and that integrally extends from one elongate side-member to the other, opposing elongate side-member and/or to at least one of the first and second opposing elongate end-members, and that crosses a core area of the air-transmissive window; and,
first and second opposing, parallel, elongate sidewalls that respectively integrally extend from the first and second opposing elongate side-members of the downstream base in a generally upstream direction;
wherein the frame is upstream-open-ended such that any component of the frame that is located upstream from the downstream base does not extend over, or cross over, the core area of the air-transmissive window.

2. The frame of claim 1 wherein any component of the frame that is located upstream from the downstream base does not extend over, or cross, any portion of the air-transmissive window.

3. The frame of claim 1 wherein the frame does not comprise any item that is positioned upstream of either of the first and second opposing elongate end-members, so that the frame is open at the first and second opposing ends, and wherein the first and second opposing, parallel, elongate sidewalls are configured so that the frame is closed at the first and second opposing sides, so that the frame comprises a space for receiving the rectangular pleated air filter media, the space being closed at the first and second opposing sides and open at the first and second opposing ends.

4. The frame of claim 1 wherein the frame comprises first and second opposing, parallel, elongate endwalls that respectively integrally extend from the first and second opposing elongate end-members of the downstream base in a generally upstream direction, with the first and second opposing, parallel, elongate endwalls and the first and second opposing, parallel, elongate sidewalls collectively forming a rectangular box that defines, and outwardly bounds, a space for receiving the rectangular pleated air filter media.

5. The frame of claim 1 wherein the frame comprises first and second upstream side-tabs that respectively extend integrally inward from upstream ends of the first and second opposing, parallel, elongate sidewalls of the frame, and wherein each upstream side-tab extends over a peripheral area of the air-transmissive window but does not extend over, or cross, the core area of the air-transmissive window.

6. The frame of claim 1 wherein the frame comprises at least one tether-securing feature at the first end of the frame and at least one tether-securing feature at the second, opposing end of the frame.

7. The frame of claim 6 wherein the at least one tether-securing feature comprises at least one first outward-facing notch provided in an outer edge of the first elongate end-member and at least one second outward-facing notch provided in an outer edge of the second, opposing elongate end-member.

8. The frame of claim 6 wherein the frame comprises first and second opposing, parallel, elongate endwalls that respectively integrally extend from the first and second opposing elongate end-members of the downstream base in a generally upstream direction, and wherein the at least one tether-securing feature comprises at least one first post that protrudes outward from an outward face of the first elongate endwall and at least one second post that protrudes outward from an outward face of the second, opposing, parallel, elongate endwall, the at least one second post protruding outward in an opposite direction from the at least one first post.

9. The frame of claim 8 wherein the at least one first post comprises a pair of first posts that are spaced apart from each other at least generally along a long axis of the first elongate endwall, and wherein the at least one second post comprises a pair of second posts that are spaced apart from each other at least generally along a long axis of the second, opposing, parallel, elongate endwall.

10. A rectangular pleated air filter media, the rectangular pleated air filter media comprising a pleat direction and an expansion direction and comprising first and second opposing primary edges that are non-corrugated edges and first and second opposing secondary edges that are corrugated edges, and wherein the rectangular pleated air filter media comprises at least one first tether that is configured to extend outward beyond the first primary edge of the rectangular pleated air filter media and at least one second tether that is configured to extend outward beyond the second, opposing primary edge of the rectangular pleated air filter media.

11. The rectangular pleated air filter media of claim 10 wherein the at least one first tether and the at least one second tether are provided by at least two elongate members that are each attached to multiple upstream pleat tips of the rectangular pleated air filter media and that each comprises first and second ends that respectively extend outward beyond the first and second primary edges of the rectangular pleated air filter media.

12. The rectangular pleated air filter media of claim 11 wherein the first and second ends of the at least two elongate members are configured to wrap around first and second ends of a rigid frame and to be secured to the perimeter frame to secure the rectangular pleated air filter media to the rigid frame.

13. The rectangular pleated air filter media of claim 10 wherein the at least one first tether and the at least one second tether are provided by at least two elongate members that are each attached to multiple upstream pleat tips of the rectangular pleated air filter media, each elongate member being in the form of a continuous loop that extends around the first and second primary edges of the rectangular pleated air filter media and that extends along a downstream side of the rectangular pleated air filter media, each of the elongate members being configured so that, with the rectangular pleated air filter media placed in a rigid frame, each elongate member can extend around first and second ends of the rigid frame and pass along a downstream side of the rigid frame to secure the rectangular pleated air filter media to the rigid frame.

14. The rectangular pleated air filter media of claim 10 wherein the at least one first tether and the at least one second tether are provided by at least two elongate members that are each attached to multiple upstream pleat tips of the rectangular pleated air filter media and that each comprises first and second ends that respectively extend outward beyond the first and second primary edges of the rectangular pleated air filter media, the first and second ends each comprising a narrow neck and an enlarged terminal head that are configured to allow the end of the tether to be secured to a tether-securing feature of a rigid frame.

15. The rectangular pleated air filter media of claim 10 wherein the at least one first tether and the at least one second tether are provided by a continuous loop that comprises first and second parallel, spaced-apart segments that are each attached to multiple upstream pleat tips of the rectangular pleated air filter media, with the continuous loop comprising a first section that extends outward beyond the first primary edge of the rectangular pleated air filter media and a second section that extends outward beyond the second primary edge of the rectangular pleated air filter media, so that the first section of the continuous loop can be secured to at least one first tether-securing feature at the first end of a rigid frame and so that the second section of the continuous loop can be secured to at least one second tether-securing feature at the second end of the rigid frame.

16. The rectangular pleated air filter media of claim 10 wherein the at least one first tether and the at least one second tether are provided by at least two discrete, separate entities that are respectively attached to opposing end panels of the rectangular pleated air filter media, the entities each comprising a narrow neck and an enlarged terminal head that are configured to allow the tether to be secured to a tether-securing feature of a rigid frame.

17. The rectangular pleated air filter media of claim 10 wherein at least one of the tethers is an integral extension of a pleat-stabilizing, expansion-limiting member that is attached to multiple upstream pleat tips of the rectangular pleated air filter media.

18. The rectangular pleated air filter media of claim 10 wherein at least one of the tethers is a separately-made item that is attached to a pleat-stabilizing, expansion-limiting member that is attached to multiple upstream pleat tips of the rectangular pleated air filter media.

19. A method of making a framed air filter, comprising:
positioning the rectangular pleated air filter media of claim 10 in a filter-receiving space on an upstream side of a rigid frame, and
securing the at least one first tether to the rigid frame and securing the at least one second tether to the rigid frame.

20. A framed air filter comprising the rectangular pleated air filter media of claim 10 and an upstream-open-ended rigid frame to which the rectangular pleated air filter media is secured by the at least one first tether and the at least one second tether, with the rectangular pleated air filter media being positioned in a filter-receiving space on an upstream side of the upstream-open-ended rigid frame.
